(19) United States
(12) Patent Application Publication
(10) Pub. No.: US 2008/0233893 A1
(43) Pub. Date: Sep. 25, 2008

(54) Wireless Tranceiver Configuration with Self-Calibration for Improved Out of Band Interferer Rejection

(75) Inventor: David Duperray, Redwood City, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/997,197

(22) PCT Filed: Jul. 28, 2006
(86) PCT No.: PCT/IB2006/052596

§ 371 Date: Jan. 29, 2008

Related U.S. Application Data
(60) Provisional application No. 60/703,794, filed on Jul. 29, 2005.

(51) Int. Cl. H04B 1/40

(52) U.S. Cl. 455/77

(57) ABSTRACT

The present wireless transceiver includes a tuneable narrow band LNA which rejects dramatically any out of band interferers. The tuneable narrow band LNA may be operable over a wide frequency band. A loopback calibration procedure is used to control the tuneable narrow band LNA so as to produce a substantially flat gain characteristic over the band of interest.

Currently, many wireless systems use a wideband LNA (Low Noise Amplifier) in the receiver chain. Increasingly, wireless systems are operating over a wide frequency range: for 802.11a, the frequency of operation is from 4.9 GHz to 6.0 GHz and for UWB, the band of operation covers several GHz. The LNA, which is the first stage of a receiver chain (after the antenna(s) and the front-end filter(s) if any), needs to provide a high enough gain and a low noise figure over the entire band of operation.

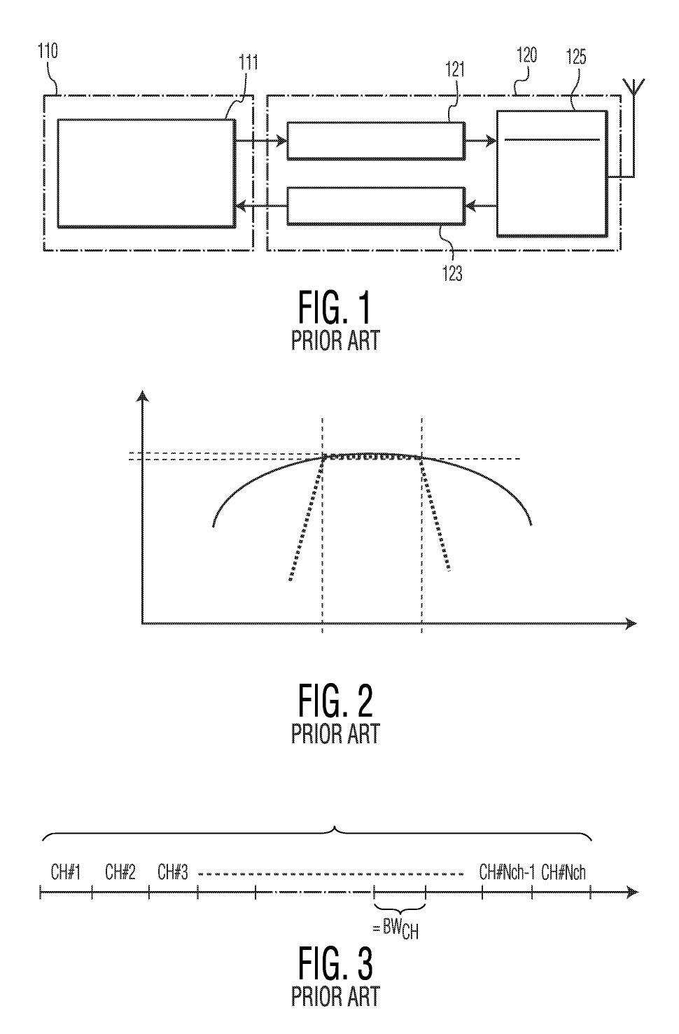

A conventional half duplex wireless transceiver, such as for 802.11a/g (or any other half duplex wireless system), has an architecture as shown in FIG. 1: a baseband section 110 (including a Digital Signal Processor and Analog Functions like A/D and D/A, block 111) and an RF section 120 (including a transmit path 121, a receive path 123, a front-end 125 which includes Tx/Rx switch and RF filters).

Defining the beginning and the end of the band of reception by Fbegin and Fend, the reception bandwidth is: BWRX=Fend−Fbegin. A wireless system has to be able to receive any signal in the frequency range from Fbegin to Fend. That is why the LNA in today's receiver path is designed to have a high gain that is as flat as possible over the entire receiver band, as shown in FIG. 2. Unfortunately, the LNA is in fact amplifying with a non-negligible gain any interferer below Fbegin or above Fend. To avoid the amplification of these interferers, the front-end (in front of the LNA block) usually includes a filter which attenuates sharply interferers below Fbegin or above Fend, as shown in FIG. 2.

Note that the number of operating channels in the reception band is defined by

$$Nch = \frac{{BW}_{RX}}{{BW}_{CH}}$$

where BW_{CH} is the bandwidth of one channel, as shown in FIG. 3.

The following reference is exemplary of the state of the art:

[1] “A 2.5 dB NF direct-conversion receiver front-end for HiperLAN2/IEEE802.11a” Paola Rossi, Antonio Liscidini, Massimo Brandolini, Francesco Svelto, ISSCC 2004 conference.

The present wireless transceiver includes a tuneable narrow band LNA which rejects dramatically any out of band interferers.

The present may be more fully understood from the following description in conjunction with the appended drawing figures. In the drawing:

FIG. 1 is a block diagram of a typical half duplex wireless transceiver.

FIG. 2 a waveform diagram showing typical LNA and front-end filter responses in a wireless system.

FIG. 3 is a diagram showing the definition of receiver band channels.

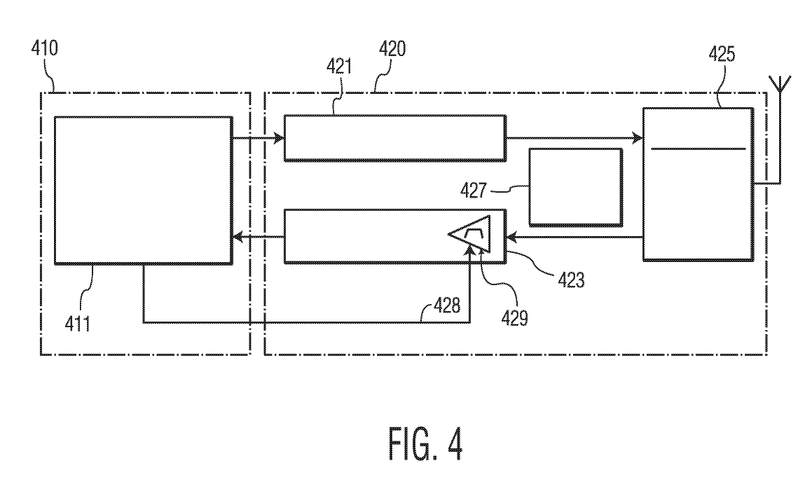

FIG. 4 is a block diagram of a wireless system in accordance with an exemplary embodiment of the present invention.

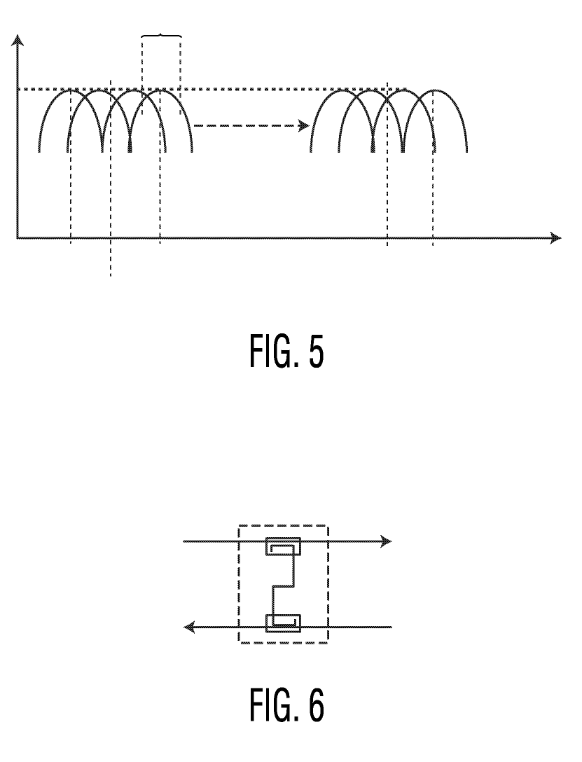

FIG. 5 is a waveform diagram showing the frequency response of the tuneable LNA of FIG. 4.

FIG. 6 is a diagram showing an example of a Tx to Rx coupling element.

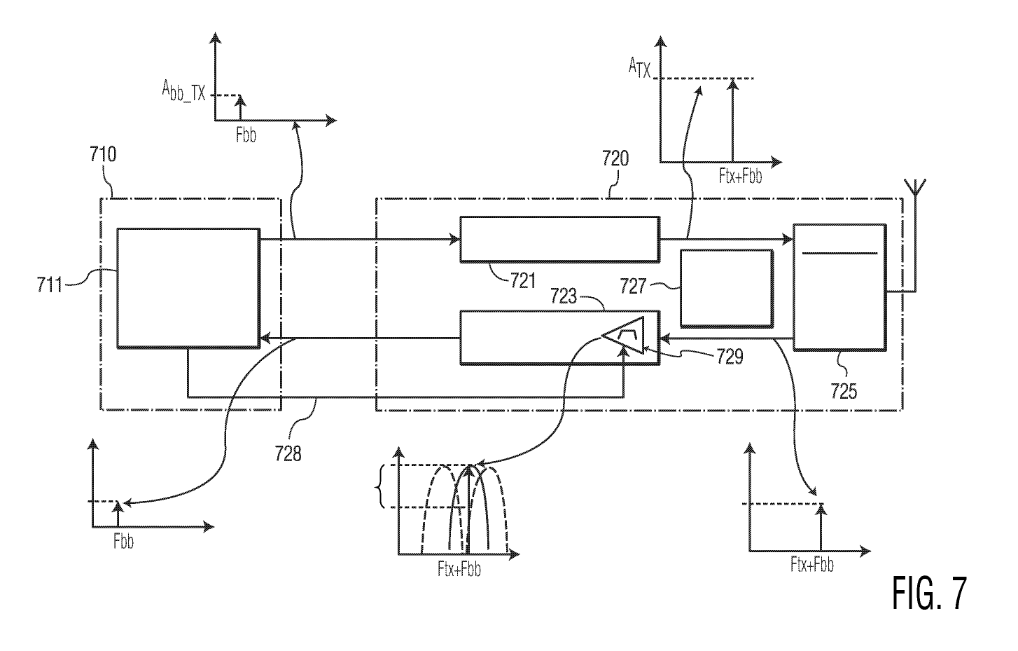

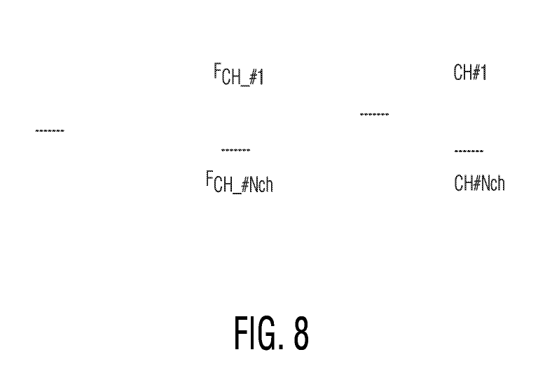

FIG. 7 is a block diagram of the transceiver of FIG. 4 illustrating operation during loopback mode.

FIG. 8 is an example of a lookup table (LUT) used to determine LNA control signal values in the transceiver of FIG. 4.

Referring now to FIG. 4, a block diagram of the present wireless transceiver is shown.

The wireless system includes a narrow band tuneable LNA 429, a Tx to Rx coupling element 427, and a LNA tuner control signal 428 coming from the baseband processor 411 which controls the LNA tuner. (The elements 410, 420, 421, 423 and 425 correspond to like elements described previously in relation to FIG. 1.) The narrow band tuneable LNA can be designed, for example, as in the IEEE paper referenced in [1]. The frequency response of the tuneable LNA may be as shown in FIG. 5.

The tuneable LNA response should be designed such that:

it covers the entire receiver band. However for a particular tuned frequency Ftuned, the tuned LNA response should show a bandwidth such that:

BWCH<BWtuned_LNA<BWRX.

The LNA tuning range should cover more than the reception bandwidth BWRX to compensate for any chip process and temperature variations

The Tx to Rx coupling element may be composed of two directional couplers, for example, as shown in FIG. 6.

A Tx to Rx coupling element can also be designed with microstrip lines on a PCB to which the wireless transceiver is soldered.

Due to process variations, the tuneable LNA has to be calibrated. To perform this calibration, the transceiver should be capable of RF loopback (this means that the transceiver should be able to transmit and receive at the same time even if the system itself is TDD only, as is the case for the 802.11a/b/g system). After calibration, the transceiver should be able to down-convert its own transmitted signal to get nominal signal swing at the receiver baseband output and maximum out of band rejection at the LNA as illustrated in FIG. 7 (which assumes a TDD system where the transmitted frequency and the receive frequency are the same). In FIG. 7, the elements 710, 711, 720, 721, 723, 725, 727 and 728 correspond to like elements described previously in relation to FIG. 4.

The calibration can run when the system is powered up but also (if necessary) in response to any large temperature variation the transceiver may experience (this implies that the transceiver should have a temperature sensor which most of today's wireless systems have).

The following calibration procedure may be used to adjust properly the LNA tuner:

Step #1:

Turn on transmit chain, receive chain, the TX to RX coupling element and switch off any antenna switching element in the front-end.

Step#2:

Set the transmit frequency=receive frequency=CH#1 (channel of the receive operating band; see FIG. 3).

Step #3:

Set the transmit power to a low power which can be sufficiently amplified by the receiver chain (after going through the TX to RX coupling element) to get a nominal baseband demodulated signal of amplitude Abb_RX.

Step #4:

Sweep the LNA tuner frequency Fi from lowest frequency Ftuner_min to the highest frequency Ftuner_max (see FIG. 5) and measure the baseband receive amplitude Abb_RX.

Step #5:

Find the index i of the tuner frequency Fi for which the baseband receive amplitude is maximum. Call the found index iCH_{—}#1

Step #6:

Repeat step #2 to step #5 for all other channels of receive operating band (see FIG. 3).

Step #7:

Save in the baseband memory a lookup table (LUT), an example of which is shown in FIG. 8.

Step #8:

The calibrated receiver will use the LUT defined in step #7 during normal operation.

What is claimed is:

1. A method of receiving a communications signal within a wide frequency band using a transceiver including a transmitter and a receiver, the receiver including a frequency-tuneable narrowband amplifier, comprising: establishing a loopback path from the transmitter to the receiver; using the loopback path, calibrating the amplifier within at least two different sub-bands within the wide frequency band to obtain amplifier settings for each of the two different sub-bands; at a first time, applying first amplifier settings to the amplifier to receive a communications signal within the first sub-band; and at a second time, applying second amplifier settings to the amplifier to receive a communications signal within the second sub-band.

2. The method of claim 1, wherein calibration compensates for at least one of process variations and temperature variations.

3. The method of claim 1, wherein the amplifier has a frequency response that rejects significantly any interferers out of a desired reception band.

4. A wireless transceiver for receiving a communications signal within a wide frequency band, comprising: a transmitter and a receiver, the receiver including a frequency-tuneable narrowband amplifier; means for establishing a loopback path from the transmitter to the receiver; means for, using the loopback path, calibrating the amplifier within at least two different sub-bands within the wide frequency band to obtain amplifier settings for each of the two different sub-bands; means for, at a first time, applying first amplifier settings to the amplifier to receive a communications signal within the first sub-band, and at a second time, applying second amplifier settings to the amplifier to receive a communications signal within the second sub-band.

5. The apparatus of claim 4, wherein calibration compensates for at least one of process variations and temperature variations.

6. The apparatus of claim 4, wherein the amplifier has a frequency response that rejects significantly any interferers out of a desired reception band.

7. A wireless transceiver for receiving a communications signal within a wide frequency band, comprising: a transmitter and a receiver, the receiver including a frequency-tuneable narrowband amplifier; coupling circuitry for establishing a loopback path from the transmitter to the receiver; calibration circuitry for, using the loopback path, calibrating the amplifier within at least two different sub-bands within the wide frequency band to obtain amplifier settings for each of the two different sub-bands; control circuitry for, at a first time, applying first amplifier settings to the amplifier to receive a communications signal within the first sub-band, and at a second time, applying second amplifier settings to the amplifier to receive a communications signal within the second sub-band.

8. The apparatus of claim 4, wherein calibration compensates for at least one of process variations and temperature variations.

9. The apparatus of claim 4, wherein the amplifier has a frequency response that rejects significantly any interferers out of a desired reception band.
